(19) United States
(12) Patent Application Publication
(10) Pub. No.: US 2011/0280644 A1
(43) Pub. Date: Nov. 17, 2011

(54) CUTTER DEVICE, PRINTER AND CONTROLLER THEREOF

(75) Inventor: Chiharu Toyoshima, Miyagi (JP)

(73) Assignee: TOSHIBA TEC KABUSHIKI KAISHA, Tokyo (JP)

(21) Appl. No.: 13/106,253

(22) Filed: May 12, 2011

(30) Foreign Application Priority Data
May 13, 2010 (JP) 2010-111351

(51) Int. Cl. B41J 11/66; B26D 1/20; B26D 5/00

(52) U.S. Cl. 400/621; 83/74; 83/13

(57) ABSTRACT

Embodiments described herein are to a cutter device includes a fixed blade, a movable blade configured to move along the fixed blade to cut a paper interposed between the movable blade and the fixed blade. The cutter device further includes a drive mechanism configured to transfer a drive torque to the movable blade, so that the movable blade is driven to move along the fixed blade, and a detection unit configured to detect whether an abnormality in cutting the paper has occurred in the course of the movement of the movable blade. The cutter device further includes a control unit, upon detection of the abnormality in cutting the paper by the detection unit, configured to control the drive mechanism to increase the drive torque to be transferred to the movable blade.

### CROSS-REFERENCE TO RELATED APPLICATIONS

This application is based upon and claims the benefit of priority from Japanese Patent Application No. 2010-111351, filed on May 13, 2010, the entire contents of which are incorporated herein by reference.

### FIELD

Embodiments described herein relate generally to a cutter device, a printer and a controller thereof.

### BACKGROUND

A cutter device may move a movable blade along a fixed blade that is disposed in a direction traversing printed paper, to thereby cut the printed paper interposed between the blades. Such a cutter device moves the movable blade by using a stepping motor as a driving power source, and controls the rotational speed of the stepping motor in a stepwise manner. Specifically, the cutter device controls the rotational speed of the stepping motor using three speed control intervals: an acceleration interval in which the rotational speed of the stepping motor is accelerated to reach a predetermined speed from a point of time when it is idle or in a standby state; a constant speed interval in which the stepping motor is driven to rotate at the predetermined speed; and a deceleration interval, in which the rotational speed of the stepping motor is decelerated from the predetermined speed until it stops rotation.

Unfortunately, in such a cutter device, when the load required for cutting a paper exceeds a preset torque of the stepping motor, the stepping motor may not be driven to rotate as intended (i.e., the stepping motor may stall or miss a step), and thus is not able to continue subsequent cutting operations. For this reason, a stepping motor is typically designed to produce a high torque covering a peak load required for a paper cutting operation.

However, the load required for cutting paper may widely vary. As such, even if a high torque motor is employed, the load required for cutting the paper may exceed the full torque of the motor. In addition, the use of a high torque motor, which may be excessive for a normal paper cutting operation, increases the costs associated with a motor and a drive circuit to drive the motor, and also causes unnecessary consumption of electric power.

### BRIEF DESCRIPTION OF THE DRAWINGS

FIG. 1 is a perspective view showing a configuration of a printer according to one illustrative embodiment.

FIG. 2 is a front view of a cutter device according to one illustrative embodiment.

FIG. 3 is a side view of the cutter device shown in FIG. 2.

FIG. 4 is a perspective view of a cutter device in which guide plates are mounted.

FIG. 5 is a side view of a carriage according to one illustrative embodiment.

FIG. 6 is a block diagram showing a hardware configuration of a printer according to one illustrative embodiment.

FIG. 7 is a block diagram showing a functional configuration of a printer according to one illustrative embodiment.

FIG. 8 is a graph showing the relation between a rotational speed and a drive torque of a stepping motor.

FIG. 9 is a graph showing an exemplary procedure of controlling a rotational speed of a stepping motor according to one illustrative embodiment.

FIG. 10 is a graph showing an exemplary procedure of controlling a rotational speed of a stepping motor until an abnormality in cutting a paper receipt is detected.

FIG. 11 is a graph showing an exemplary procedure of controlling a rotational speed of a stepping motor when an abnormality in cutting the paper receipt is detected.

FIG. 12 is a graph showing another exemplary procedure of controlling a rotational speed of a stepping motor when an abnormality in cutting the paper receipt is detected.

### DETAILED DESCRIPTION

According to one embodiment, a cutter device includes a fixed blade, a movable blade configured to move along the fixed blade to cut a paper interposed between the movable blade and the fixed blade. The cutter device further includes a drive mechanism configured to transfer a drive torque to the movable blade, so that the movable blade is driven to move along the fixed blade, and a detection unit configured to detect whether an abnormality in cutting the paper has occurred in the course of the movement of the movable blade. The cutter device further includes a control unit, upon detection of the abnormality in cutting the paper by the detection unit, configured to control the drive mechanism to increase the drive torque to be transferred to the movable blade.

Embodiments will now be described in detail with reference to the drawings.

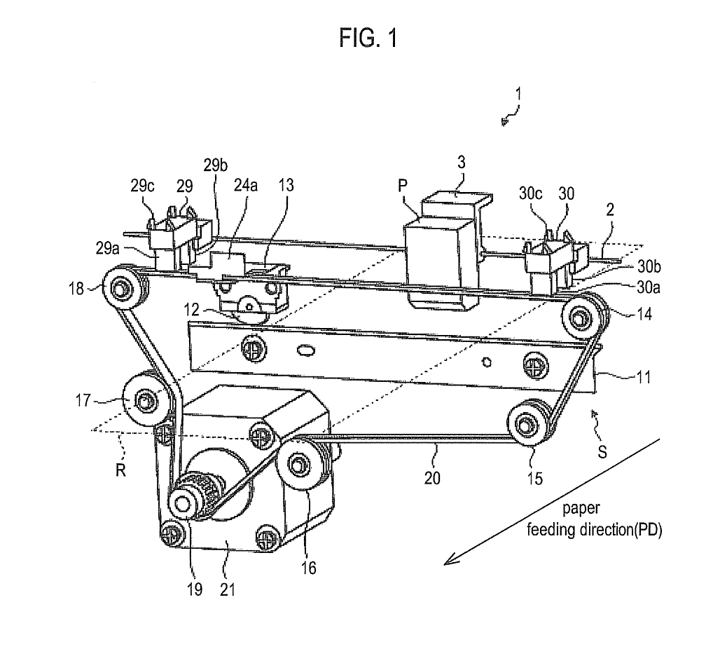

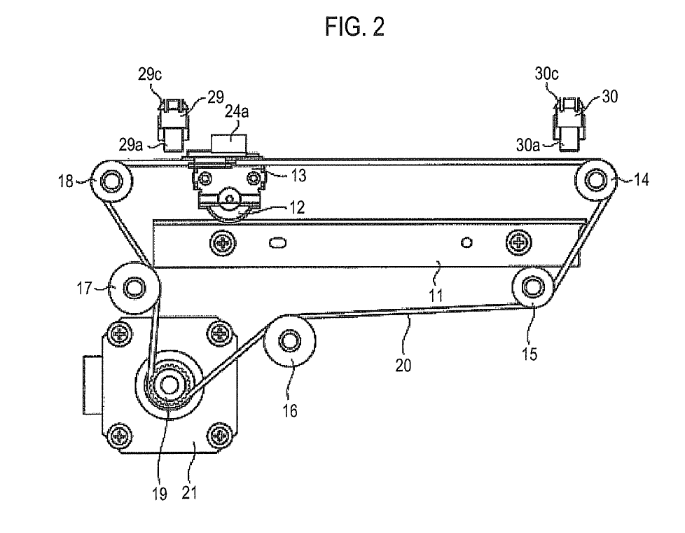

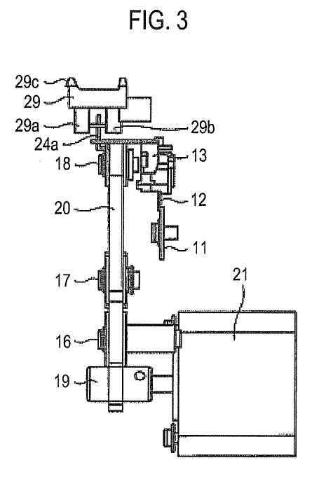

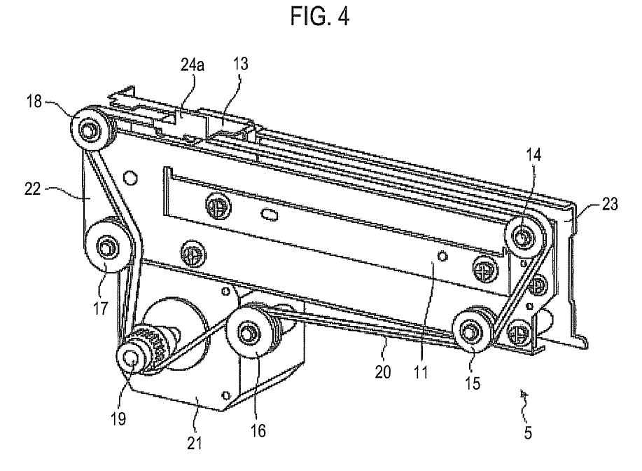

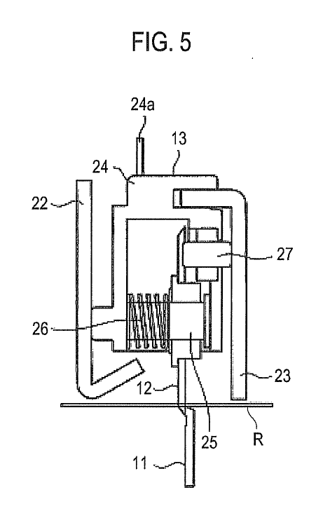

FIG. 1 is a perspective view showing a configuration of a printer according to one illustrative embodiment. FIG. 2 is a front view of a cutter device according to one illustrative embodiment. FIG. 3 is a side view of the cutter device shown in FIG. 2. FIG. 4 is a perspective view of a cutter device in which guide plates are mounted. FIG. 5 is a side view of a carriage according to one illustrative embodiment.

As shown in FIG. 1, a printer 1 according to one illustrative embodiment includes a printing unit P, and a cutter device S disposed downstream from the printing unit P in a direction PD of feeding a receipt paper R. The printing unit P is pivotably supported by a carriage 3 configured to move along a shaft 2 mounted in a direction intersecting with the paper feeding direction PD.

As shown in FIGS. 1 to 3, the cutter device S includes a fixed blade 11, and a movable blade 12 configured to move in a direction approximately perpendicular to the paper feeding direction PD to thereby cut the receipt paper R interposed between the fixed blade 11 and the movable blade 12.

The fixed blade 11 is disposed across the receipt paper R, and is formed in the shape of a flat plate having a length that is equal to or greater than a width of a receipt paper with the largest size which is available for printing in the printer 1. In this embodiment, as shown in FIG. 4, the fixed blade 11 is provided to be interposed between a pair of guide plates 22 and 23 so that the fixed blade 11 is disposed in parallel with the pair of guide plates 22 and 23. In this arrangement, the fixed blade 11 is integrally fixed to the pair of guide plates 22 and 23, e.g., through screws. Further, an elongated slot may be formed on each of the guide plates 22 and 23, through which the receipt paper R passes.

The movable blade 12 is a disc-shaped blade which is turnably supported by a carriage 13 traveling along the longitudinal direction of the fixed blade 11. The movable blade 12 moves in the longitudinal direction of the fixed blade 11, which is driven by the movement of the carriage 13, and also slides on the fixed blade 11 such that the movable blade 12 and the fixed blade 11 are in frictional contact with each other. Thus, the receipt paper R interposed between the fixed blade 11 and the movable blade 12 is cut by the engagement of the fixed and movable blades 11 and 12.

While in the above embodiment, the movable blade 12 has been explained to rotate in frictional contact with the fixed blade 11 and cut the receipt paper R interposed therebetween, the present disclosure may not be limited thereto. For example, in an alternate embodiment, the movable blade 12, such as a round blade (e.g., a disc-shaped blade) as described above, may be configured to move along the longitudinal direction of the fixed blade 11 without rotating to thereby cut the receipt paper R interposed between the fixed blade 11 and the movable blade 12. Further, in another alternate embodiment, the movable blade 12 may be configured to move in a direction approximately perpendicular to a printed surface of the receipt paper R and cut the receipt paper R interposed between the fixed blade 11 and the movable blade 12.

The carriage 13 in which the movable blade 12 is mounted, serves to move the movable blade 12 in the longitudinal direction of the fixed blade 11. As shown in FIG. 5, the carriage 13 includes a carriage frame 24, a shaft 25, a spring 26, and a rotating member 27.

The carriage frame 24 covers the shaft 25, the spring 26 and the rotating member 27 disposed therein. The shaft 25 turnably and pivotably supports the movable blade 12 with respect to the carriage 13. The carriage frame 24 includes a plate member 24a vertically mounted on the top surface of the carriage frame 24. The plate member 24a is used in detecting whether the carriage 13 reaches home positions HP (e.g., located at two opposite end positions of the shaft 2) where the movable blade 12 is positioned after cutting the receipt paper R.

The spring 26 is configured to urge the movable blade 12, which is pivotably supported by the shaft 25, against the carriage frame 24, so that the motion of the movable blade 12 is limited within the carriage frame 24.

The rotating member 27, which is mounted between one side of the movable blade 12 facing the guide plate 23 and the guide plate 23, prevents the movable blade 12 from being inclined within the carriage frame 24. Further, the rotating member 27 rotates in conjunction with the movement of the carriage 13 by means of the frictional contact between the rotating member 27 and the guide plate 23, so that the movable blade 12 rotates in a direction of cutting the receipt paper R. With this arrangement, the movable blade 12 cuts the receipt paper R while rotating in a direction of traversing the receipt paper R, thereby allowing the outer periphery of the movable blade 12 to be uniformly used, and thus, prolonging the lifespan of the movable blade 12.

Referring back to FIGS. 1 to 3, the carriage 13 is connected to a ring-shaped endless belt 20 which is stretched between a plurality of pulleys 14 to 18 and a motor gear 19. The inner surface of the endless belt 20 includes tooth-marks (not shown) formed along its entire perimeter. The tooth-marks formed on the endless belt 20 are engaged with the teeth of the motor gear 19 which is driven to rotate by a drive torque generated by the stepping motor 21, thereby driving the plurality of pulleys 14 to 18 to rotate and move the carriage 13 connected to the endless belt 20.

The carriage 13, the plurality of pulleys 14 to 18, the motor gear 19, the endless belt 20 and the stepping motor 21 as described above constitute a drive mechanism which serves to transfer the drive torque generated by the stepping motor 21 to the movable blade 12 and move the movable blade 12.

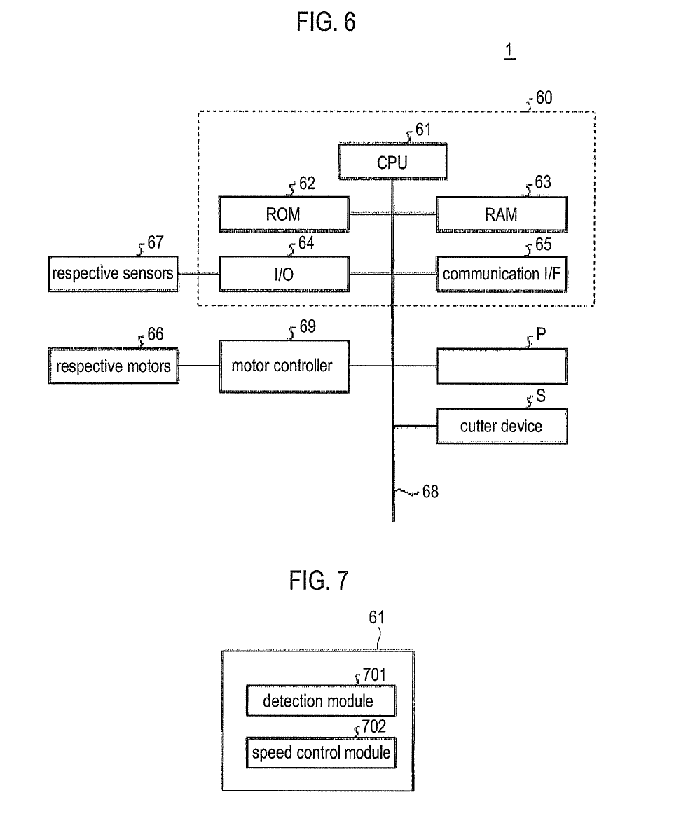

The stepping motor 21 is operated in response to driving pulses provided from a control unit 60 (see FIG. 6). The drive torque generated by the stepping motor 21 is transferred to the motor gear 19. Specifically, the stepping motor 21 is configured to generate a higher drive torque at a lower rotational speed. While in this embodiment, the stepping motor 21 has been explained to obtain a higher drive torque at a lower rotational speed, the present disclosure may not be limited thereto. For example, in an alternate embodiment, a direct current (DC) motor may be used in which voltage to be applied thereto is switched between two levels. That is, if a lower voltage is applied to the DC motor, the rotational speed of the DC motor is decelerated to produce a higher drive torque.

At the two home positions HP (positions C and D in FIG. 9) for the carriage 13, first and second sensors 29 and 30 are respectively disposed to detect (or sense) the plate member 24a of the carriage 13 when the carriage 13 reaches the respective home positions HP after the movable blade 12 completes cutting the receipt paper R.

The first and second sensors 29 and 30 may include transparent sensors which include respectively light-emitting diodes 29a and 30a configured to emit light, and light-receiving elements 29b and 30b which face the respective light-emitting diodes 29a and 30a and are configured to receive light emitted from the respective light-emitting diodes 29a and 30a. The plate member 24a, which is mounted on carriage 13, moves along a path between light-emitting diode 29a (30a) and the opposing light-receiving element 29b (30b).

Clips 29c and 30c are formed on the top surfaces of the first and second sensors 29 and 30, respectively. The clips 29c and 30c are inserted into corresponding engagement holes formed on a case of the printer 1 so that the clips 29c and 30c are engaged with the peripheral portions of the respective engagement holes. In this manner, the first and second sensors 29 and 30 are fixed to the case of the printer 1.

FIG. 6 is a block diagram showing a configuration of a printer and electrical connections between respective components in the printer according to one illustrative embodiment. As shown in FIG. 6, the printer 1 includes a control mechanism 60. The control mechanism 60 includes a CPU 61, a ROM (read only memory) 62, a RAM (random access memory) 63, I/O (input/output) port 64 having an input port, through which information is transferred to the CPU 61, and an output port, through which information provided from the CPU 61 is transferred to external units (e.g., respective components contained in the printer 1). Further, the control mechanism 60 includes a communication interface (I/F) 65 configured to communicate with a higher-level device to receive operation data such as print data and cutting instruction data from the higher-level device or transmit data associated with failures or defects occurred at the printer 1 to the higher-level device. These components as described above are connected with each other via a bus line 68. A variety of sensors 67 such as the first and second sensors 29 and 30 are also connected to the I/O port 64.

The ROM 62 stores therein various programs or data. The RAM 63 functions as a working area for temporarily storing data or programs while the CPU 61 executes various programs. Further, the RAM 63 includes a print buffer and a character generator, and the data stored in the RAM 63 may be maintained by a backup battery. A motor controller 69, which controls the printing unit P, the cutter device S and various motors 66 (e.g., the stepping motor 21, etc.), is connected to the CPU 61 via the bus line 68. The CPU 61 controls the afore-mentioned components by executing various programs stored in the ROM 62. When the plate member 24a of the carriage 13 is detected by the first sensor 29 or the second sensor 30, the detection result is directed to the CPU 61. Based on the detection result, the CPU 61 controls the cutter device S, as will be described in detail later.

FIG. 7 is a block diagram showing a functional configuration of a printer according to one illustrative embodiment. The CPU 61 of the printer 1 according to one embodiment executes the various programs stored in the ROM 62 to implement a detection module 701 and a speed control module 702.

The detection module 701 is configured to detect whether an abnormality in cutting the receipt paper R has occurred during the movement of the movable blade 12. In this embodiment, the detection module 701 determines that an abnormality in cutting the receipt paper R has occurred during the movement of the movable blade 12, if the sensor 29 (or the sensor 30) fails to detect the plate member 24a of the carriage 13 even after the speed control module 702 (as will be described later) applies a predetermined number of driving pulses to the stepping motor 21 so as to move the carriage 13 to the first home position HP where the sensor 29 is provided (or the second home position HP where the sensor 30 is provided).

For the purpose of performing an operation of cutting the receipt paper R, the speed control module 702 is configured to apply to the stepping motor 21 the predetermined number of driving pulses which is required to move the carriage 13 to one of the home positions HP, thereby driving the stepping motor 21 to rotate. In this embodiment, the speed control module 702 may change a period (or frequency) of applying the driving pulses to the stepping motor 21 so that the rotational speed of the stepping motor 21 is controlled in a stepwise manner.

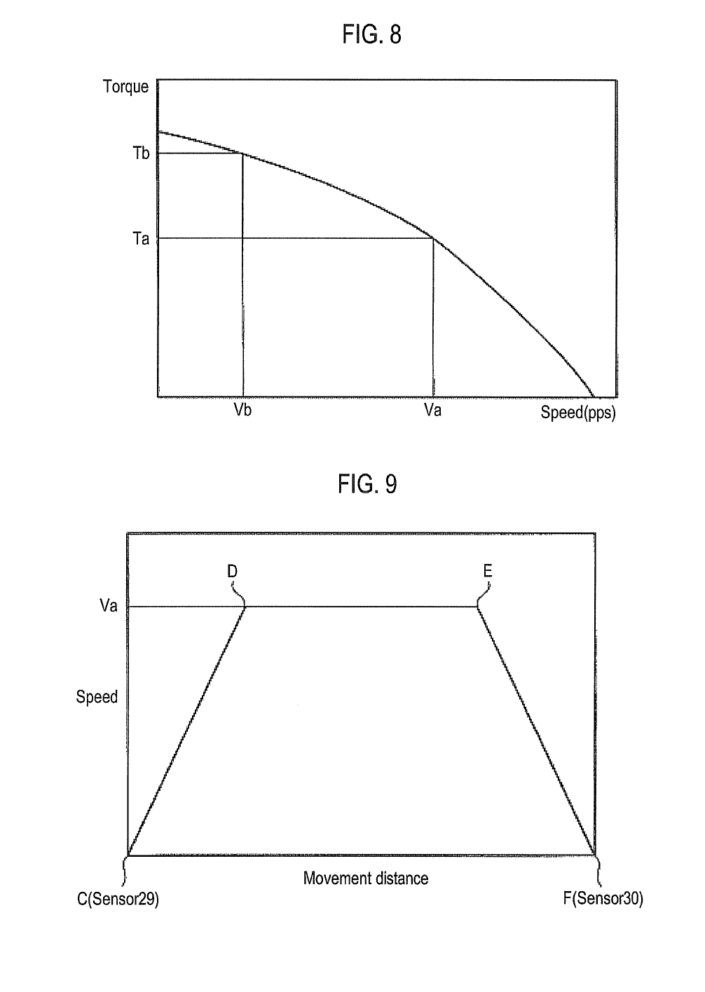

The following is a description of the relation between a rotational speed and a drive torque of the stepping motor 21. FIG. 8 is a graph showing the relation between a rotational speed and a drive torque of the stepping motor 21. As shown in FIG. 8, the stepping motor 21 produces a lower drive torque at a higher rotational speed, while providing a higher drive torque at a lower rotational speed. For example, in the stepping motor 21, a drive torque Ta produced at a rotational speed Va is lower than a drive torque Tb produced at a rotational speed Vb, which is slower than the rotational speed Va. If a load moving the movable blade 12 (that is driven by the drive torque transferred from the stepping motor 21) exceeds the drive torque produced by stepping motor 21, the stepping motor 21 may fail to rotate in synchronism with the driving pulses provided thereto (i.e., the stepping motor 21 may stall or miss steps). This causes the movement distance of the movable blade 12 to be shorter than what is intended or causes the stepping motor 21 to stop the movement.

FIG. 9 is a graph showing an exemplary procedure of controlling a rotational speed of a stepping motor according to one illustrative embodiment. With reference to FIG. 9, the following is a description of an exemplary procedure for controlling a rotational speed of the stepping motor 21 for a time interval during which the carriage 13 moves from the first home position HP (where the first sensor 29 is disposed) up to the second home position HP (where the second sensor 30 is disposed). For the purpose of controlling the rotational speed of the stepping motor 21, the speed control module 702 divides an interval in which the carriage 13 moves from the first sensor 29 to the second sensor 30, into three subintervals: a first subinterval in which the carriage 13 moves from the first home position HP where the first sensor 29 is disposed (hereinafter referred to as a “point C”) to a point D; a second subinterval between the point D and a point E; and a third subinterval in which the carriage 13 moves from the point E to the second home position HP where the second sensor 30 is disposed (hereinafter referred to as a “point F”).

Specifically, the speed control module 702 defines the first subinterval (i.e., between the points C to D) as an acceleration interval in which a frequency of applying driving pulses to the stepping motor 21 is gradually increased so that the rotational speed of the stepping motor 21 is accelerated up to the rotational speed Va from an idle state where the stepping motor 21 does not rotate. Further, the speed control module 702 defines the second subinterval (i.e., between the points D to E) as a constant-speed interval in which a frequency of applying driving pulses to the stepping motor 21 is maintained at a constant value so that the stepping motor 21 rotates at a constant speed (i.e., at the rotational speed Va). Further, the speed control module 702 defines the third subinterval (i.e., between the points E to F) as a deceleration interval in which a frequency of applying driving pulses to the stepping motor 21 is gradually decreased so that the rotational speed Va of the stepping motor 21 is gradually decelerated until the stepping motor 21 stops rotation (i.e., idle state).

In the constant-speed interval, the stepping motor 21 rotates at a high speed (e.g., Va) and produces a low drive torque (e.g., Ta as shown in FIG. 8). Thus, if a load required for the movable blade 12 to cut the receipt paper R exceeds the drive torque Ta, the stepping motor 21 may miss steps and thus the cutter device S may not function properly.

In designing a cutting device such as the cutter device S, the load required for a paper cutting operation depends on various use conditions which are generally taken into account, so that the motor can produce sufficient performance to cover the estimated paper cutting load and various drive conditions. In addition, the speed of the cutter device S for cutting the receipt paper R affects the printing speed of the printer 1. Thus, a cutter device with a higher cutting speed is required to enhance the marketability of the printer 1. Because of these issues, a cutter device may employ a motor meeting the two conflicting requirements, i.e., a high torque and a high cutting speed. However, such a motor is costly, thus leading to an increase in cost for manufacturing a printer incorporating the motor.

One of the main reasons why the cutter device S may not function properly in the course of cutting is that the cutter device S may have difficulty in cutting over perforations or there may be fiber clumps building up near the cutting blade thus overloading the drive system which may cause damage to the cutting blade or drive system (i.e. pulley, gears, etc.). For this reason, recovering from operational failures requires a high torque, while performing a normal paper cutting operation requires low torque.

As shown in FIG. 8, it is noted that the rotational speed of the stepping motor 21 can be controlled so that the stepping motor 21 selectively operates at the low torque (e.g., Ta) or at the high torque (e.g., Tb). It is generally known that the rotational speed of the stepping motor 21 can be controlled by adjusting a frequency of applying driving pulses to the stepping motor 21. Thus, controlling the frequency of applying driving pulses to the stepping motor 21 enables selective use of low and high torques in the same motor. In some embodiments, the frequency of applying driving pulses to the stepping motor 21 may be controlled by using a micro-processor in software or may be controlled by using an oscillation circuit in hardware.

In this arrangement, while the detection module 701 does not detect any abnormality in cutting the receipt paper R, the speed control module 702 controls the stepping motor 21 to operate at the rotational speed Va so that the stepping motor 21 (i.e., a drive mechanism) transfers a low drive torque to the movable blade 12. On the other hand, if the detection module 701 detects an abnormality in cutting the receipt paper R, the speed control module 702 controls the stepping motor 21 to operate at the rotational speed Vb so that the stepping motor 21 transfers a high drive torque to the movable blade 12. By doing this, in a normal cutting operation, the stepping motor 21 is operated at a high rotational speed and produces low torque, which speeds up the printing operation of the printer 1. Further, if the abnormality in cutting the receipt paper R is detected at the detection module 701, the speed control module 702 controls the stepping motor 21 to produce high torque. This makes it possible to cut the receipt paper R in a reliable manner with an inexpensive motor.

In accordance with the above embodiment, if the detection module 701 detects an abnormality in cutting the receipt paper R, the speed control module 702 controls the stepping motor 21 to operate at the rotational speed Vb by applying a predetermined number of driving pulses, so that the stepping motor 21 (i.e., drive mechanism) transfers a high drive torque to the movable blade 12 during a predetermined time interval. Further, if the plate member 24a of the carriage 13 is detected by the first sensor 29 (or the second sensor 30) while the stepping motor 21 operates at the rotational speed Vb, the speed control module 702 stops the application of the driving pulses to the stepping motor 21. On the other hand, if the plate member 24a of the carriage 13 is not detected by the first sensor 29 (or the second sensor 30) while the stepping motor 21 operates at the rotational speed Vb by applying the predetermined number of driving pulses, the speed control module 702 determines that an error occurs in the cutting operation, and pauses the operation of cutting the receipt paper R. Accordingly, if the stepping motor 21 misses the steps even when the stepping motor 21 operates at a high torque, the speed control module 702 immediately pauses the operation of cutting the receipt paper R. This makes it possible to take prompt actions to handle the error and also avoid damage to the fixed blade 11 or the movable blade 12.

While in the above embodiment, it has been explained that if the cutting abnormality of the receipt paper R is detected, the stepping motor 21 transfers a high drive torque to the movable blade 12 during a predetermined time interval, the present disclosure may not be limited thereto. For example, in an alternate embodiment, the stepping motor 21 transfers a high drive torque to the movable blade 12 until the plate member 24a of the movable blade 12 is detected by either one of the first sensor 29 and the second sensor 30) (i.e., until the carriage 13 reaches the first or second home position HP). In this embodiment, it is possible to completely cut the receipt paper R even though it may prolong the time required for cutting the receipt paper R.

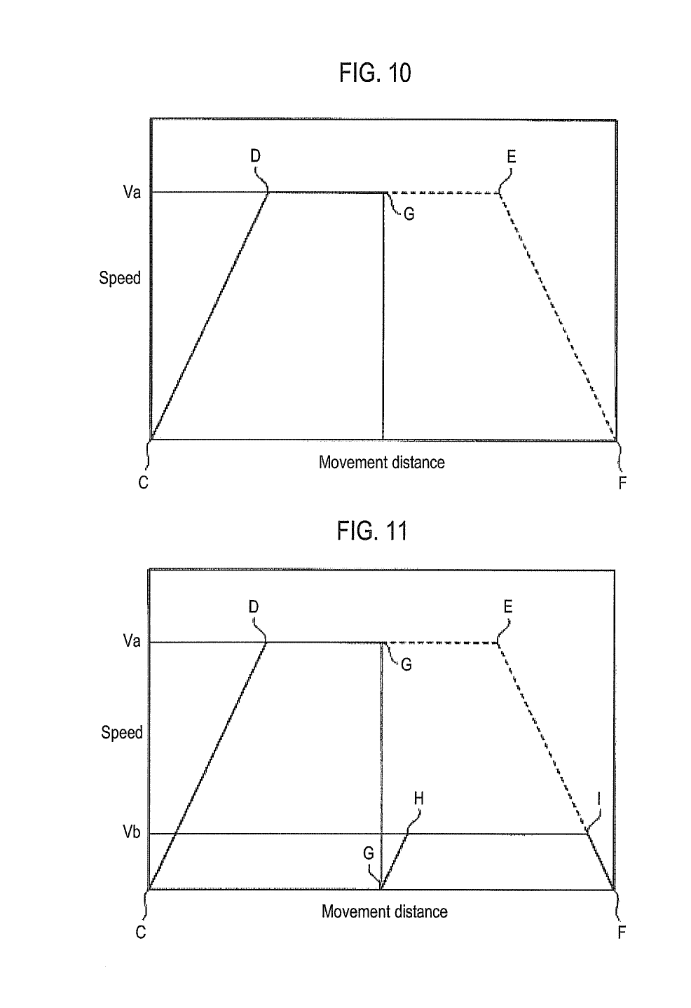

FIGS. 10 and 11 are graphs showing an exemplary procedure of controlling the rotational speed of a stepping motor according to another illustrative embodiment, respectively. Specifically, FIG. 10 shows an exemplary procedure of controlling the rotational speed of a stepping motor until an abnormality in cutting the receipt paper R is detected, and FIG. 11 shows an exemplary procedure of controlling the rotational speed of a stepping motor when an abnormality in cutting the receipt paper R is detected.

Initially, the speed control module 702 gradually increases a frequency of applying driving pulses to the stepping motor 21 during a time interval in which the carriage 13 moves from the point C to the point D, so that the rotational speed of the stepping motor 21 is accelerated up to the rotational speed Va. From the time when the carriage 13 reaches the point D, the speed control module 702 applies the driving pulses to the stepping motor 21 at regular intervals until the carriage 13 reaches a point E, so that the rotational speed of the stepping motor 21 is maintained at the rotational speed Va. At this time, if an abnormality in cutting the receipt paper R is detected by the detection module 701, e.g., at a point G between the points D and E, and the carriage 13 is stopped at the point G, the speed control module 702 suspends the application of the driving pulses to the stepping motor 21 (see FIG. 10).

Afterwards, as shown in FIG. 11, the speed control module 702 resumes the application of the driving pulses to the stepping motor 21 during a time interval between the point G and a point H, by gradually increasing the frequency of applying the driving pulses to the stepping motor 21, so that the rotational speed of the stepping motor 21 is increased up to a rotational speed Vb from the idle state. Thereafter, when the carriage 13 reaches the point H, the speed control module 702 applies the driving pulses to the stepping motor 21 at regular intervals, so that the rotational speed of the stepping motor 21 is maintained at the rotational speed Vb, until the carriage 13 reaches a point I. Then, when the carriage 13 reaches the point I, the speed control module 702 gradually decreases the frequency of applying the driving pulses to the stepping motor 21 during a time interval in which the carriage 13 reaches a point F from the point I, so that the rotational speed of the stepping motor 21 is decreased down to zero (i.e., the idle state) from the rotational speed Vb.

In accordance with the printer 1 with the configuration as described above, if an abnormality in cutting the receipt paper R is detected by the detection module 701, the speed control module 702 controls the stepping motor 21 to rotate at the rotational speed Vb so that the stepping motor 21 transfers a high drive torque to the movable blade 12. As a result, it is possible to operate the stepping motor 21 at a high speed (and producing a low torque) in a normal operation of cutting the receipt paper R, thereby speeding up the printing speed of the printer 1. Further, it is possible to operate the stepping motor 21 at a low speed (and producing a high torque), if an abnormality in cutting the receipt paper R is detected, thereby cutting the receipt paper R in a reliable manner using an inexpensive motor

In another embodiment, if an abnormality in cutting the receipt paper R is detected, the speed control module 702 controls the movable blade 12 to move in a reverse direction (e.g., in a direction away from the second home position HP) and then controls the stepping motor 21 to operate at the rotational speed Vb, so that the stepping motor 21 transfers a high drive torque to the movable blade 12 and the movable blade 12 moves in a forward direction (e.g., toward the second home position HP). In the following description, the same reference numerals used for explaining the printer 1 according to the above embodiments refer to the same elements, and thus, a description thereof will be omitted to avoid duplication herein. Only elements of the present embodiment different from those of the above embodiments will be described in detail.

If an abnormality in cutting the receipt paper R is detected by the detection module 701, the speed control module 702 controls the rotation of the stepping motor 21 so that the movable blade 12 is driven to move in a reverse direction (e.g., in a direction away from the second home position HP). Afterwards, the speed control module 702 controls the stepping motor 21 to operate at the rotational speed Vb so that the stepping motor 21 transfers a high drive torque to the movable blade 12 and the movable blade 12 moves again in a forward direction (e.g., toward the second home position HP).

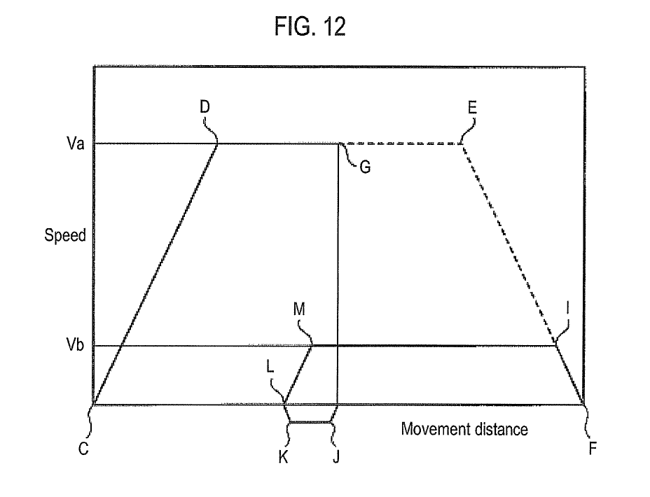

FIG. 12 is a graph showing an exemplary procedure of controlling the rotational speed of a stepping motor according to one embodiment. In FIG. 12, the part of the graph showing the control of the rotational speed of the stepping motor 21 until an abnormality in cutting the receipt paper R is detected (i.e., during an internal from the point C to the point G), is similar to the corresponding part of the graph shown in FIG. 10, and thus, a description thereof will be omitted to avoid duplication herein.

From the time when the application of the driving pulses to the stepping motor 21 is suspended (i.e., when an abnormality is detected), the speed control module 702 applies negative driving pulses to the stepping motor 21 during a time interval between points G and J. During this time interval, the speed control module 702 gradually increases a frequency of applying the negative driving pulses to the stepping motor 21, so that the rotational speed of the stepping motor 21 is increased up to a predetermined speed from the idle state. In this embodiment, it is assumed that the speed control module 702 applies positive driving pulses to the stepping motor 21 so as to move the movable blade 12 in the forward direction (e.g., toward the second home position HP).

Thereafter, when the carriage 13 reaches the point J, the speed control module 702 applies negative driving pulses to the stepping motor 21 at regular intervals during a time interval in which the carriage 13 reaches a point K from the point J, so that the rotational speed of the stepping motor 21 is maintained at a predetermined speed. Upon reaching the point K, the speed control module 702 gradually decreases a frequency of applying the negative driving pulses to the stepping motor 21 during a time interval in which the carriage 13 reaches a point L from the point K, so that the rotational speed of the stepping motor 21 is decreased to zero (i.e., idle state) from the predetermined speed.

Then, when the carriage 13 reaches the point L and the application of negative driving pulses to the stepping motor 21 is stopped, the speed control module 702 resumes the application of positive driving pulses to the stepping motor 21 during a time interval from the point L to a point M. During this time interval, the speed control module 702 gradually increases a frequency of applying the positive driving pulses to the stepping motor 21, so that the rotational speed of the stepping motor 21 is increased up to the rotational speed Vb from the idle state. Afterwards, upon reaching the point M, the speed control module 702 applies positive driving pulses to the stepping motor 21 at regular intervals until the carriage 13 reaches a point I, so that the rotational speed of the stepping motor 21 is maintained at the rotational speed Vb. When the carriage 13 reaches the point I, the speed control module 702 gradually decreases a frequency of applying the positive driving pulses to the stepping motor 21 during a time interval in which the carriage 13 reaches a point F from the point I, so that the rotational speed of the stepping motor 21 is decreased from the rotational speed Vb until it goes to the idle state.

In accordance with the printer 1 with the configuration as described above, if an abnormality in cutting the receipt paper R is detected by the detection module 701, the speed control module 702 controls the stepping motor 21 to allow the movable blade 12 to move in the reverse direction (e.g., in a direction away from the second home position HP). Afterwards, the speed control module 702 controls the stepping motor 21 to operate at the rotational speed Vb so that the stepping motor 21 transfers a high drive torque to the movable blade 12 and the movable blade 12 moves in the forward direction (e.g., toward the second home position HP). As a result, if an abnormality in cutting the receipt paper R is detected (e.g., the receipt paper R is jammed between the fixed blade 11 and the movable blade 12), the jammed receipt paper R can be immediately released from the fixed blade 11 and the movable blade 12. Then, when the operation of cutting the receipt paper R is resumed, the movable blade 12 can be driven with high torque to cut the receipt paper R. This allows the receipt paper R to be steadily cut even with an inexpensive motor.

While the program executed in the printer 1 of the above embodiments may be provided to be stored in the ROM 62, the present disclosure is not limited thereto. For example, the program may be provided to be recorded in a computer-readable recording medium such as a CD-ROM, a flexible disk (FD), a CD-R or a DVD (Digital Versatile Disk) as an installable or executable file.

In addition, the program executed in the printer 1 of the above embodiments may be stored in a computer connected to a network such as the Internet or the like so that the program can be down-loaded from the computer via the network. Moreover, the program executed in the printer 1 of the above embodiments may be provided or disseminated via a network such as the Internet or the like.

As described above, in accordance with the printer 1 of the above embodiments, it is possible to cut a paper sheet in a reliable manner even with an inexpensive motor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A cutter device, comprising:
a fixed blade;
a movable blade configured to move along the fixed blade to cut a paper interposed between the movable blade and the fixed blade;
a drive mechanism configured to transfer a drive torque to the movable blade, so that the movable blade is driven to move along the fixed blade;
a detection unit configured to detect whether an abnormality in cutting the paper has occurred in the course of the movement of the movable blade; and
a control unit, upon detection of the abnormality in cutting the paper by the detection unit, configured to control the drive mechanism to increase the drive torque to be transferred to the movable blade.

2. The cutter device of claim 1, wherein upon detection of the abnormality in cutting the paper by the detection unit, the control unit is configured to control the drive mechanism to increase the drive torque to be transferred to the movable blade during a predetermined time interval.

3. The cutter device of claim 1, wherein upon detection of the abnormality in cutting the paper by the detection unit, the control unit is configured to control the drive mechanism to increase the drive torque to be transferred to the movable blade until the movable blade reaches a target position to completely cut the paper.

4. The cutter device of claim 1, wherein upon detection of the abnormality in cutting the paper by the detection unit, the control unit is configured to control the derive mechanism to move the movable blade in a direction opposing a target position, and further configured to control the drive mechanism to increase the drive torque to be transferred to the movable blade and move the movable blade in a direction toward the target position.

5. The cutter device of claim 1, wherein the movable blade is a round blade configured to rotate while being in frictional contact with the fixed blade.

6. The cutter device of claim 1, further comprising: a carriage configured to support the movable blade, wherein the carriage is driven by the drive mechanism to travel along the longitudinal direction of the fixed blade.

7. The cutter device of claim 6, further comprising a sensor provided at the target position and configured to detect the carriage when the carriage reaches the target position after the movable blade completes cutting the paper,
wherein the detection unit determines that an abnormality in cutting the paper is occurred in the course of the movement of the movable blade, if the sensor fails to detect the carriage even after the control unit controls the drive mechanism so as to move the carriage to the target position.

8. A printer, comprising:
a fixed blade;
a movable blade configured to move along the fixed blade to cut a paper interposed between the movable blade and the fixed blade;
a drive mechanism configured to transfer a drive torque to the movable blade, so that the movable blade is driven to move along the fixed blade;
a detection unit configured to detect whether an abnormality in cutting the paper has occurred in the course of the movement of the movable blade; and
a control unit, upon detection of the abnormality in cutting the paper by the detection unit, configured to control the drive mechanism to increase the drive torque to be transferred to the movable blade.

9. The printer of claim 8, wherein upon detection of the abnormality in cutting the paper by the detection unit, the control unit is configured to control the drive mechanism to increase the drive torque to be transferred to the movable blade during a predetermined time interval.

10. The printer of claim 8, wherein upon detection of the abnormality in cutting the paper by the detection unit, the control unit is configured to control the drive mechanism to increase the drive torque to be transferred to the movable blade until the movable blade reaches a target position to completely cut the paper.

11. The printer of claim 8, wherein upon detection of the abnormality in cutting the paper by the detection unit, the control unit is configured to control the derive mechanism to move the movable blade in a direction opposing a target position, and further configured to control the drive mechanism to increase the drive torque to be transferred to the movable blade and move the movable blade in a direction toward the target position.

12. The printer of claim 8, wherein the movable blade is a round blade configured to rotate while being in frication contact with the fixed blade.

13. The printer of claim 8, further comprising: a carriage configured to support the movable blade, wherein the carriage is driven by the drive mechanism to travel along the longitudinal direction of the fixed blade.

14. The printer of claim 13, further comprising a sensor provided at the target position and configured to detect the carriage when the carriage reaches the target position after the movable blade completes cutting the paper,
wherein the detection unit determines that an abnormality in cutting the paper is occurred in the course of the movement of the movable blade, if the sensor fails to detect the carriage even after the control unit controls the drive mechanism so as to move the carriage to the target position.

15. A method of controlling a cutting device, the method comprising:
producing a drive torque by a drive mechanism to drive a movement of a movable blade along a fixed blade to cut a paper interposed between the movable blade and the fixed blade;
detecting by a detection unit whether an abnormality in cutting the paper is occurred in the course of the movement of the movable blade; and
upon detection of the abnormality in cutting the paper by the detection unit, controlling by a control unit the drive mechanism to increase the drive torque to drive the movement of the movable blade.

16. The method of claim 15, wherein the controlling comprises, upon detection of the abnormality in cutting the paper by the detection unit, controlling by the control unit the drive mechanism to increase the drive torque to drive the movement of the movable blade during a predetermined time interval.

17. The method of claim 15, wherein the controlling comprises, upon detection of the abnormality in cutting the paper by the detection unit, controlling by the control unit the drive mechanism to increase the drive torque to drive the movement of the movable blade until the movable blade reaches a target position to completely cut the paper.

18. The method of claim 15, wherein the controlling comprises:
upon detection of the abnormality in cutting the paper by the detection unit, controlling by the control unit the drive mechanism to move the movable blade in a direction opposing a target position; and
controlling the drive mechanism to increase the drive torque to drive the movement of the movable blade and move the movable blade in a direction toward the target position.

19. A controller comprising:
a drive mechanism that produces a drive torque to drive a movement of a movable blade along a fixed blade to cut a paper interposed between the movable blade and the fixed blade;
a detection unit that determines whether an abnormality in cutting the paper has occurred in the course of the movement of the movable blade; and
a control unit that, upon detection of the abnormality in cutting the paper by the detection unit, controls the drive mechanism to increase the drive torque to drive the movement of the movable blade.
